(19) United States
(12) Patent Application Publication
(10) Pub. No.: US 2008/0165080 A1
(43) Pub. Date: Jul. 10, 2008

(54) Back to Back Lcd Flat Panel Display

(76) Inventors: Degapudi Janardhana Reddy, Chennai (IN); Lakshmanan Narayanan, Chennai (IN)

Correspondence Address: ABELMAN, FRAYNE & SCHWAB, 666 THIRD AVENUE, 10TH FLOOR, NEW YORK, NY, 10017, US

(21) Appl. No.: 11/994,329

(22) PCT Filed: Aug. 31, 2005
(86) PCT No.: PCT/IN2005/000290

§ 371 Date: Dec. 28, 2007

(30) Foreign Application Priority Data
Jun. 28, 2005 (IN) 815/CHE/2005

(51) Int. Cl. G06F 1/16

(52) U.S. Cl. 345/1.1

(57) ABSTRACT

A back-to-back replica display facility for a computer uses LCD flat panel displays, including first and second LCD flat panel displays, with the first display being a master display facing in a first direction for displaying a first image, and with the second display being a slave display facing in a second direction opposite to the first direction, with the second display exactly fitting the back of the first display and the second display displays a second image identical to the first image. The first and second LCD flat panel displays may include thin film transistor (TFT) LCDs. The second display may include a control button for controlling the operation of the second display, such as the contrast, power on and off, and screen size of the second display. A mechanism may be included for selectively tilting the first and second displays.

### CROSS-REFERENCE TO RELATED APPLICATIONS

This application is a 371 of international application number PCT/IN2005/000290, filed on Aug. 31, 2005.

### BACKGROUND OF THE INVENTION

1. Field of the Invention

This invention relates to computers and in particular to desktop computers. More specifically, the invention relates to a display monitor which is an output device, and the invention helps in the presentation of documents and materials with ease, convenience and comfort to exchange information when more than one person who are physically present and opposite to each other are involved in usage of the output of the same computer.

2. Description of the Related Art

Computers are used in particular by hospitals, doctors, marketing professionals, billing counters, railway/bus ticketing counters, hotel billing and other situations to present information such as pictorial clinical condition to a patient, inputting patient data, billing information, or data to prospective clients in a one-to-one or one-to-many person situations. As shown in FIG. 1, the clients or customers 2 are one or more people in an office setting sitting or standing opposite to the presenter 1 across the table or counter as shown in a typical illustration of a prior art arrangement as shown in FIG. 1.

It is customary for the prior art computers 3, as shown in FIG. 1, to have a single display which is either a cathode ray tube (CRT) based display or a thin film transistor liquid crystal display (TFT LCD) based flat screen of different sizes. Generally these computers are single user computers for their individual purposes or work. When an exchange of information is required across the table using computers by more than one person or when more than one person has to look at the visuals presented in the computer screen, then the person who is using the screen of the computer in the prior art has to verbally exchange the content of the screen to the one or more group of customers sitting or standing opposite. Many times, this results in a misunderstanding or typographical errors occurring, such as in a name through a mistyping of a character etc. while entering the data. The process takes longer time, also inconveniencing both the user and customer.

To have the view of the screen, the screen has to be properly positioned such as at 45 degrees to both the customer 2 and the presenter 1, as shown in FIG. 1, so that both may view the screen. The customers have to adjust their seating or standing posture by leaning over the table or counter to get a glimpse of the screen on what is presented in the screen, or sometimes the presenter finds it more difficult to view as well as to present the data, or he has to memorize the whole screen. Many times a customer does not understand what information the presenter is entering into the computer, or the response which the presenter received from the computer such as billing information, name etc., and the customer has to obtain such information verbally to make a decision. For example, in a pharmacy, the buyer will not know the data entered by the seller such as the name of the patient, the name of the doctor, an address etc., and the correctness of such details including the total bill value until the seller tells it verbally to the buyer.

In yet another typical case, for a cardio thoracic surgeon explaining a cardiac block using a filmed angiography recording to his patient who is sitting opposite across a table, using a desktop computer, the patient will find it difficult to see the screen properly as explained by the surgeon regarding his clinical condition.

There have been many proposals to overcome this presentation and viewing problems but in all cases, at any particular time either only the presenter 1 or the client 2 will be able to view the data comfortably or else two separate monitors have to be used. That increases the financial costs, space considerations and operational costs.

### SUMMARY OF THE INVENTION

To overcome such deficiencies, the dual display technique of the present invention presents an unique approach to the usage of computers in exchanging information in public places. This will popularize the use of computers in a better way to exchange ideas and enhance collective objectives. Also this invention opens up unlimited possibilities of usage with proper software written to utilize the inventive features in areas such as teaching, clinical meetings, sales presentation, and billing to name a few applications.

In the present invention, a back-to-back replica display screen for desktop computer is disclosed.

The back-to-back replica display facility for computers using an LCD flat panel display includes a basic master display facing one side and a second slave display exactly fitting the back of the master display facing the other side, and controls are provided to adjust or modify the second slave display having different features such as contrast, power off, and screen size controls with an all sides tilting mechanism.

To assist with understanding the invention, reference will now be made to the accompanying drawings, which show examples of the present invention.

### BRIEF DESCRIPTION OF THE DRAWINGS

The foregoing aspects and many of the attendant advantages of this invention will become more readily appreciated as the same becomes better understood by reference to the detailed description, when taken in conjunction with the accompanying drawings, wherein:

FIG. 1 is an illustrative example of a typical application setup for a user-client setting in a public place normally as in the prior art.

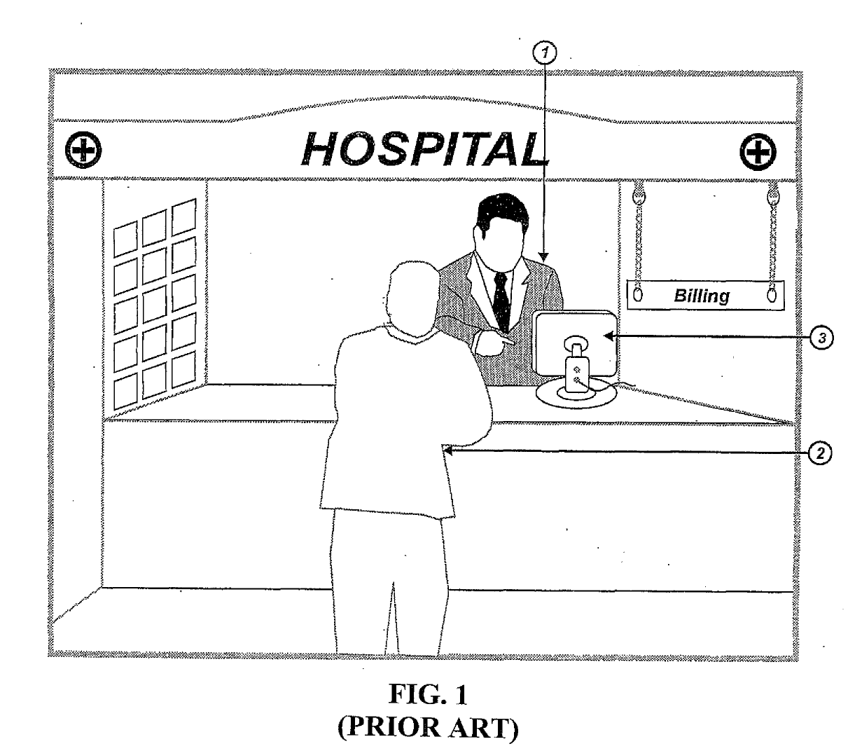

FIG. 2 is an illustrative example of the present invention exposing the second slave display which shows the present invention, in which both the presenter 1 and viewer 2 can see the presentation with ease.

FIGS. 3A-3F illustrate different views of the present invention for simultaneous viewing ability and tilting methods.

FIG. 4 shows how both LCDs are interconnected to have a dual replica of images.

FIG. 5 shows all generic TFT LCD input interface signals.

### DETAILED DESCRIPTION OF THE PREFERRED EMBODIMENTS

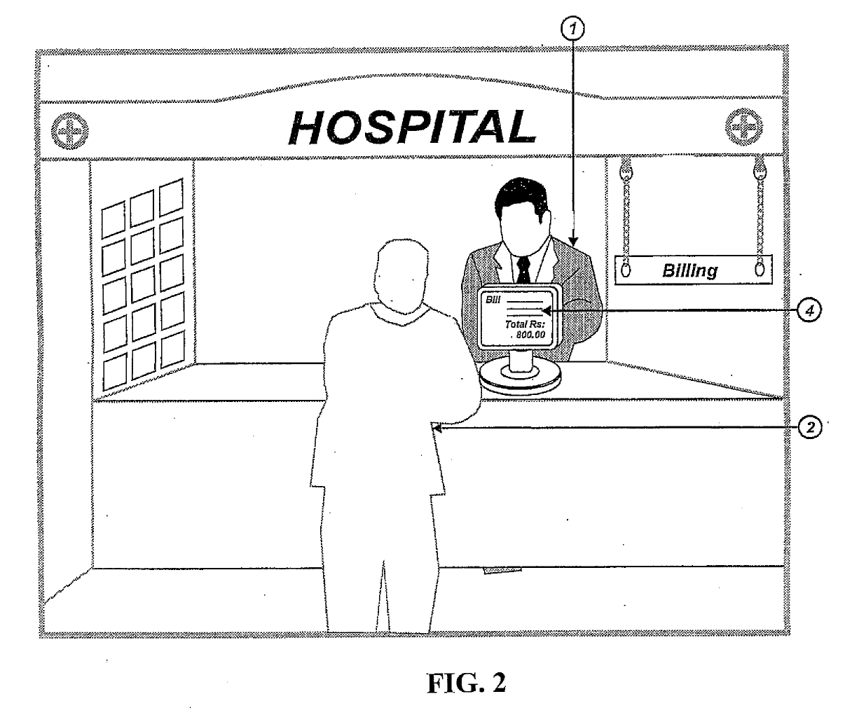

The heart of the invention is a pair of display parts to replicate the contents displayed in one display to another display fixed at the back of the first display. The present invention is directed to providing an apparatus that overcomes the foregoing and other disadvantages. More specifically, the present invention is directed to providing a method for simultaneous viewing of a screen by the presenter 1 as well as by the client 2 who are sitting or standing quite opposite to each other as illustrated in FIG. 2 in a typical example.

A back-to-back dual display facility in a desktop computer having back-to-back TFT LCD displays is disclosed. A set of display devices 4 are added back-to-back so that the second slave display 4 will face the client 2 standing or sitting opposite to the presenter 1.

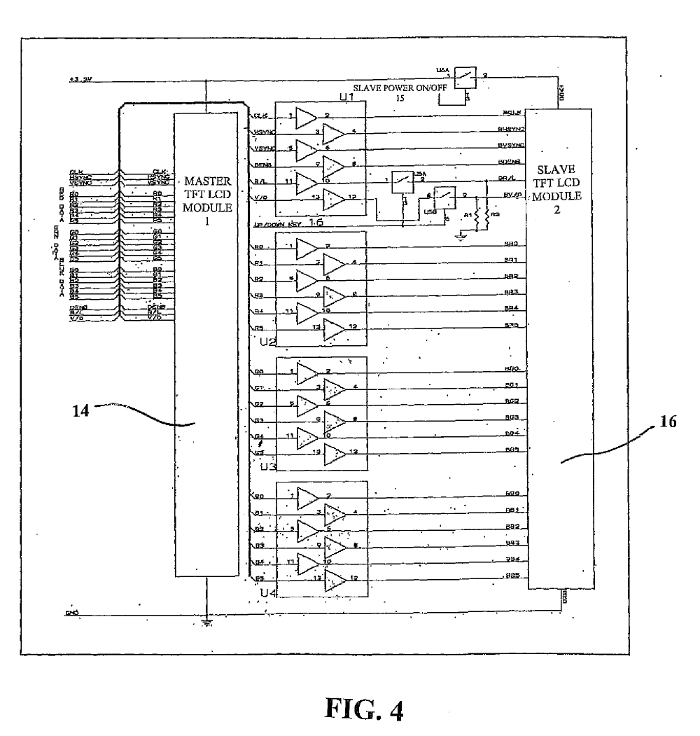

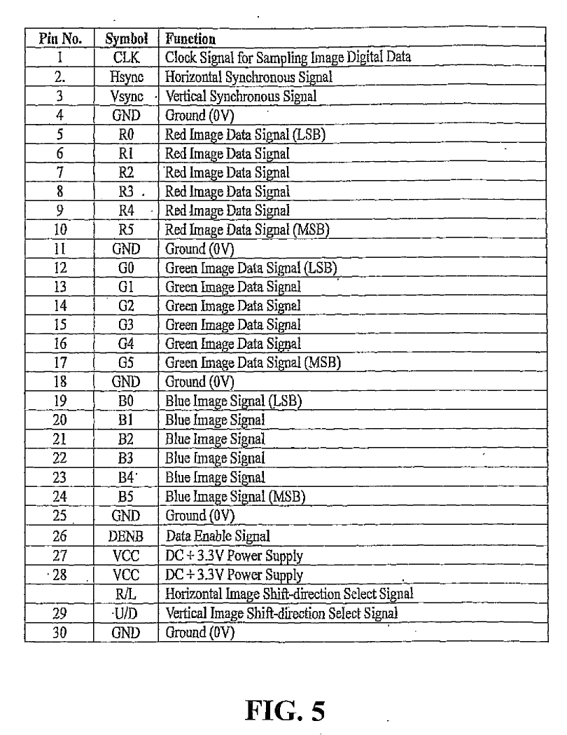

In accordance with one aspect of invention, since both the displays are of same type and same size, and also provide by the same manufacturer, the drive signals are similar in nature and generally the signals are as listed in FIG. 5. These signals are to be buffered by a set of high speed buffers as shown in FIG. 4 and wired to the second slave display 4.

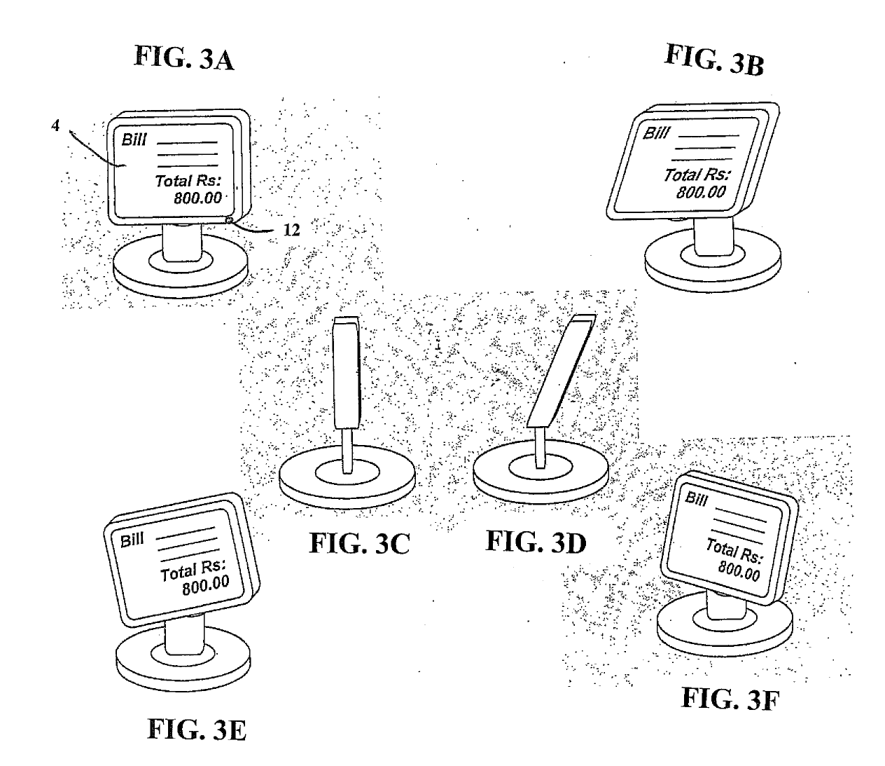

In accordance with still another aspect of invention, by switching off the power signals from a 3.3V supply to the TFT LCD along with a backlight source input supply to the TFT LCD, the second slave display 4 can be selectively switched off, allowing the computer screen of the master display to be used as a normal computer screen by an single user. For this, a key or button can be provided in the front of the second screen, such as a button 12 shown in FIG. 3A, so that the presenter/user can selectively switch-off the second slave display 4, as well as to control other functions of the display 4, such as contrast, power on and off, and screen size.

In accordance with yet another aspect of the present invention, one of the displays can be switched off while not in use or when not required either by software or by hardware.

In accordance with another aspect of the present invention, the dual display is a replica of the display parts, such that the TFT LCD screen is fixed back-to-back as illustrated in FIG. 3 along with the suitable signal drive mechanisms. Also many tilting mechanisms can be provided to tilt individual displays. It is appreciated that various changes can be made therein without departing from the scope and spirit of the present invention as illustrated in FIG. 3.

It will be appreciated that the disclosed method and circuit is advantageous in that they allow another passive viewer 2 to have a replica view of the screen viewed by the presenter 1.

The general operation of the preferred embodiment of the present invention is illustrated in FIG. 2. Both of the LCDs are placed back-to-back to be mounted on tiltable hinges as illustrated in FIGS. 3A-3F. The mechanical housing is made such that it houses both the LCDs and also it is sleek as far as possible.

FIG. 4 illustrates the wiring of the two TFT LCDs together to provide a replica image on the screen. The first LCD 14 labeled “MASTER TFT LCD MODULE 1” is the master LCD which is located on the front side of the screen as shown in FIGS. 3A-3F. The second LCD 16 labeled “SLAVE TFT LCD MODULE 2” is located on a rear side of the screen as shown in FIGS. 3A-3F. Each of the red-green-blue (RGB) format color signals has six bits which are outputted by a VGA card from the display driver subsystems of the computer which are buffered by three corresponding high speed buffers U2 to U4 and connected to the second LCD 16. Similarly the signals labeled CLK, HSYNC, and VSYNC are three vital signals which are again buffered by high speed buffers U1 and connected to the LCD 16. The other signals of the first LCD 14 which are buffered are a Data Enable Signal (DENB), a horizontal image shift direction select signal, labeled R/L, and a vertical image shift direction select signal labeled U/D.

It will be appreciated that the high speed buffers U1 to U4 allows another LCD to be wired with the same type or a similar type of LCD to have a replica image on the screen.

Also it will be appreciated that using a semiconductor power switch such as a metal oxide semiconductor field effect transistor (MOSFET) switch to the slave LCD display can be connected to the button 12 in FIG. 3A, to be switched ON and OFF as desired by the user. Also, by using a high speed analog switch across the lines labeled R/L and U/D, the user can switch the whole picture upside down.

While the preferred embodiments of the invention has been illustrated and described, it will be apparent that various changes can be made therein without departing from the spirit and scope of the invention. For example, dissimilar display devices can be wired as long as the signal conversion or modification is done to suit the requirements of the LCDs. Consequently, within the scope of the appended claims, it will be appreciated that the invention can be practiced otherwise than as specifically described herein.

Also while an embodiment of the invention has been described, it will be apparent that instead of using a LCD as a display device, a CRT type monitor can also be wired according with suitable interface driver and it will be within the scope and spirit of the invention.

What is claimed is:

1. (canceled)

2. A back-to-back replica display facility for a computer using liquid crystal display (LCD) flat panel displays comprising:
first and second LCD flat panel displays;
wherein the first display is a master display facing in a first direction for displaying a first image; and
wherein the second display is a slave display facing in a second direction opposite to the first direction, with the second display exactly fitting the back of the first display and the second display displays a second image identical to the first image.

3. The back-to-back replica display facility of claim 2, wherein the first and second LCD flat panel displays include thin film transistor (TFT) LCDs.

4. The back-to-back replica display facility of claim 2, wherein the second display includes a control button for controlling the operation of the second display.

5. The back-to-back replica display facility of claim 4, wherein the control button controls at least one of the contrast, power on and off, and screen size of the second display.

6. The back-to-back replica display facility of claim 2, further comprising:
a mechanism for selectively tilting the first and second displays.
